(19) United States
(12) Patent Application Publication
(10) Pub. No.: US 2009/0234655 A1
(43) Pub. Date: Sep. 17, 2009

(54) MOBILE ELECTRONIC DEVICE WITH ACTIVE SPEECH RECOGNITION

(76) Inventor: Jason Kwon, Raleigh, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/047,344

(22) Filed: Mar. 13, 2008

(51) Int. Cl. G10L 15/20

(52) U.S. Cl. 704/270.1

(57) ABSTRACT

An electronic device analyzes a voice communication for actionable speech using speech recognition. When actionable speech is detected, the electronic device may carry out a corresponding function, including storing information in a log or presenting one or more programs, services and/or control functions to the user. The actionable speech may be predetermined commands and/or speech patterns that are detected using an expert system as potential command or data input to a program.

### TECHNICAL FIELD OF THE INVENTION

The technology of the present disclosure relates generally to electronic devices and, more particularly, to a system and method for monitoring an audio communication for actionable speech and, upon detection of actionable speech, carrying out a designated function and/or providing options to a user of the electronic device.

### BACKGROUND

Mobile wireless electronic devices are becoming increasingly popular. For example, mobile telephones, portable media players and portable gaming devices are now in wide-spread use. In addition, the features associated with certain types of electronic devices have become increasingly diverse. To name a few examples, many electronic devices have cameras, text messaging capability, Internet browsing capability, electronic mail capability, video playback capability, audio playback capability, image display capability and handsfree headset interfaces.

While portable electronic device may provide the user with the ability to use a number of features, current portable electronic devices do not provide a convenient way of interacting with the features during a telephone conversation. For instance, the user-interface for accessing non-call features during a call is often difficult and time-consuming to use.

### SUMMARY

To improve a user's ability to interact with features of an electronic device while the user uses the electronic device to carry out a telephone call (or other audio communication), the present disclosure describes an improved electronic device that analyzes the telephone call for actionable speech of the user and/or the other party involved in the conversation. When actionable speech is detected, the electronic device may carry out a corresponding function, including storing information in a call log, presenting one or more features (e.g., application(s), service(s) and/or control function(s)) to the user, or some other action. The actionable speech may be, for example, predetermined commands (e.g., in the form of words or phrases) and/or speech patterns (e.g., sentence structures) that are detected using an expert system. The operation of the electronic device, and a corresponding method, may lead to an improved experience during and/or after a telephone call or other voice-based communication (e.g., a push-to-talk conversation). For instance, the system and method may allow access to information and services in an intuitive and simple manner. Exemplary types of information that may be readily obtained during the conversation may include directions to a destination, the telephone number of a contact, the current time and so forth. A number of other exemplary in-call user interface features will be described in greater detail in subsequent portions of this document.

According to one aspect of the disclosure, a first electronic device actively recognizes speech during a voice communication. The first electronic device includes a control circuit that converts the voice communication to text and analyzes the text to detect speech that is actionable by a program, the actionable speech corresponding to a command or data input upon which the program acts.

According to one embodiment of the first electronic device, the control circuit further runs the program based on the actionable speech.

According to one embodiment of the first electronic device, wherein the analysis is carried out by an expert system that analyzes words and phrases in the context of surrounding sentence structure to detect the actionable speech.

According to one embodiment of the first electronic device, the electronic device is a server, and the server transmits the command or data input to a client device that runs the program in response to the command or data input.

According to one embodiment of the first electronic device, the program is an Internet browser.

According to one embodiment of the first electronic device, the actionable speech is used to direct the Internet browser to a specific Internet webpage for accessing a corresponding service.

According to one embodiment of the first electronic device, the service is selected from one of a mapping and directions service, a directory service, a weather forecast service, a restaurant guide, or a movie listing service.

According to one embodiment of the first electronic device, the program is a messaging program to generate one of an electronic mail message, an instant message, a text message or a multimedia message.

According to one embodiment of the first electronic device, the program is a contact list.

According to one embodiment of the first electronic device, the program is a calendar program for storing appointment entries.

According to one embodiment of the first electronic device, the program controls a setting of the electronic device.

According to one embodiment of the first electronic device, the electronic device is a mobile telephone and the voice communication is a telephone call.

According to another aspect of the disclosure, a second electronic device actively recognizes speech during a voice communication. The second electronic device includes a control circuit that converts the voice communication to text and analyzes the text to detect actionable speech, the actionable speech corresponding to information that has value to a user following an end of the voice communication; and a memory that stores the actionable speech in a conversation log.

According to one embodiment of the second electronic device, the conversation log is in a text format that contains text corresponding to the actionable speech.

According to one embodiment of the second electronic device, the conversation log is in an audio format that contains audio data from the voice communication that corresponds to the actionable speech.

According to one embodiment of the second electronic device, the actionable speech corresponds to at least one of a name, a telephone number, an electronic mail address, a messaging address, a street address, a place, directions to a destination, a date, a time, or combinations thereof.

According to another aspect of the disclosure, a first method of actively recognizing and acting upon speech during a voice communication using an electronic device includes converting the voice communication to text; analyzing the text to detect speech that is actionable by a program of the electronic device, the actionable speech corresponding to a command or data input upon which the program acts; and running the program based on the actionable speech.

According to one embodiment of the first method, the analysis is carried out by an expert system that analyzes words and phrases in the context of surrounding sentence structure to detect the actionable speech.

According to one embodiment of the first method, the program is run following user selection of an option to run the program.

According to one embodiment of the first method, the program is an Internet browser.

According to one embodiment of the first method, the actionable speech is used to direct the Internet browser to a specific Internet webpage for accessing a corresponding service.

According to one embodiment of the first method, the service is selected from one of a mapping and directions service, a directory service, a weather forecast service, a restaurant guide, or a movie listing service.

According to one embodiment of the first method, the program is a messaging program to generate one of an electronic mail message, an instant message, a text message or a multimedia message.

According to one embodiment of the first method, the program is a contact list.

According to one embodiment of the first method, the program is a calendar program for storing appointment entries.

According to one embodiment of the first method, the program controls a setting of the electronic device.

According to another aspect of the disclosure a second method of actively recognizing and acting upon speech during a voice communication using an electronic device includes converting the voice communication to text; analyzing the text to detect actionable speech, the actionable speech corresponding to information that has value to a user following an end of the voice communication; and storing the actionable speech in a conversation log.

According to one embodiment of the second method, the conversation log is in a text format that contains text corresponding to the actionable speech.

According to one embodiment of the second method, the conversation log is in an audio format that contains audio data from the voice communication that corresponds to the actionable speech.

According to one embodiment of the second method, the actionable speech corresponds to at least one of a name, a telephone number, an electronic mail address, a messaging address, a street address, a place, directions to a destination, a date, a time, or combinations thereof.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a schematic diagram of a communications system in which an exemplary electronic device may communicate with another electronic device;

FIG. 2 is a schematic block diagram of the exemplary electronic device of FIG. 1; and

FIG. 3 is a flow chart representing an exemplary method of active speech recognition using the electronic device of FIG. 1.

### DETAILED DESCRIPTION OF EMBODIMENTS

Embodiments will now be described with reference to the drawings, wherein like reference numerals are used to refer to like elements throughout. It will be understood that the figures are not necessarily to scale.

In the present document, embodiments are described primarily in the context of a mobile telephone. It will be appreciated, however, that the exemplary context of a mobile telephone is not the only operational environment in which aspects of the disclosed systems and methods may be used. Therefore, the techniques described in this document may be applied to any type of appropriate electronic device, examples of which include a mobile telephone, a media player, a gaming device, a computer, a pager, a communicator, an electronic organizer, a personal digital assistant (PDA), a smartphone, a portable communication apparatus, etc.

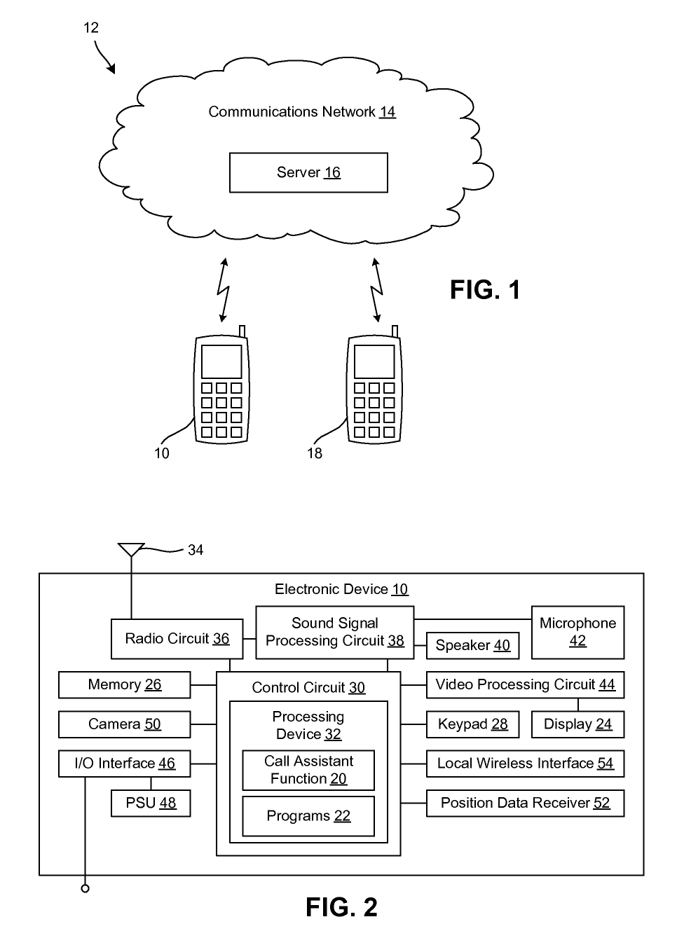

Referring initially to FIGS. 1 and 2, an electronic device 10 may be configured to operate as part of a communications system 12. The system 12 may include a communications network 14 having a server 16 (or servers) for managing calls placed by and destined to the electronic device 10, transmitting data to the electronic device 10 and carrying out any other support functions. The electronic device 10 may exchange signals with the communications network 14 via a transmission medium (not shown). The transmission medium may be any appropriate device or assembly, including, for example, a communications tower (e.g., a cellular communications tower), a wireless access point, a satellite, etc. The network 14 may support the communications activity of multiple electronic devices and other types of end user devices. As will be appreciated, the server 16 may be configured as a typical computer system used to carry out server functions and may include a processor configured to execute software containing logical instructions that embody the functions of the server 16 and a memory to store such software.

The electronic device 10 may place a call to or receive a call from another electronic device, which will be referred to as a second electronic device or a remote electronic device 18. In the illustrated embodiment, the remote electronic device 18 is another mobile telephone, but may be another type of device that is capable of allowing a user of the remote electronic device 18 to engage in voice communications with the user of the electronic device 10. Also, the communication between the electronic device 10 and the remote electronic device 18 may be a form of voice communication other than a telephone call, such as a push-to-talk conversation or a voice message originating from either of the devices 10, 18.

The remote electronic device 18 is shown as being serviced by the communications network 14. It will be appreciated that the remote electronic device 18 may be serviced by a different communications network, such as a cellular service provider, a satellite service provider, a voice over Internet protocol (VoIP) service provider, a conventional wired telephone system (e.g., a plain old telephone system or POTS), etc. As indicated, the electronic device 10 also may function over one or more of these types of networks.

Prior to describing techniques for monitoring a voice communication, an exemplary construction of the electronic device 10 when implemented as a mobile telephone will be described. In the illustrated embodiment, the electronic device 10 is described as hosting and executing a call assistant function 20 that implements at least some of the disclosed monitoring and user interface features. In other embodiments, the call assistant function 20 may be hosted by the server 16. In this embodiment, the server 16 may process voice data destined to or received from the electronic device 10 and transmit corresponding control and data messages to the electronic device 10 to invoke the described user interface features.

In the illustrated embodiment, the electronic device 10 includes the call assistant function 20. The call assistant function 10 is configured to monitor a voice communication between the user of the electronic device 10 and the user of the remote electronic device 18 for actionable speech. Based on detected actionable speech, the call assistant function 20 provides interface functions to the user. Actionable speech may be speech that may be used as a control input or as a data input to a program. Also, actionable speech may be speech that has informational value to the user. Additional details and operation of the call assistant function 12 will be described in greater detail below.

The call assistant function 12 may be embodied as executable code that is resident in and executed by the electronic device 10. In one embodiment, the call assistant function 12 may be a program stored on a computer or machine readable medium. The call assistant function 12 may be a stand-alone software application or form a part of a software application that carries out additional tasks related to the electronic device 10.

As will become more apparent below, the call assistant function 20 may interact with other software programs 22 that are stored and executed by the electronic device 10. For simplicity of the drawings, the other programs 22 are not individually identified. It will be appreciated that the programs 22 mentioned herein are representative and are not an exhaustive list of programs 22 with which the call assistant function 20 may interact. One exemplary program 22 is a setting control function. For example, an output of the call assistant function 20 may be input to a setting control function of the electronic device 10 to control speaker volume, display brightness, or other settable parameter. As another example, output from the call assistant function 20 may be input to an Internet browser to invoke a search using a service hosted by an Internet server. Exemplary services may include, but are not limited to, a general Internet search engine, a telephone directory, a weather forecast service, a restaurant guide, a mapping and directions service, a movie listing service, and so forth. As another example, the call assistant function 20 may interact with a contact list database to search for previously stored information or to store new information acquired during voice communication. Still other exemplary programs 22 include a calendar function, a clock function, a messaging function (e.g., an electronic mail function, an instant messaging function, a text message function, a multimedia message function, etc.), or any other appropriate function.

The electronic device 10 may include a display 24. The display 24 displays information to a user, such as operating state, time, telephone numbers, contact information, various menus, graphical user interfaces (GUIs) for various programs, etc. The displayed information enables the user to utilize the various features of the electronic device 10. The display 24 also may be used to visually display content received by the electronic device 10 and/or retrieved from a memory 26 of the electronic device 10. The display 24 may be used to present images, video and other graphics to the user, such as photographs, mobile television content and video associated with games.

A keypad 28 provides for a variety of user input operations. For example, the keypad 28 may include alphanumeric keys for allowing entry of alphanumeric information such as telephone numbers, phone lists, contact information, notes, text, etc. In addition, the keypad 28 may include special function keys such as a “call send” key for initiating or answering a call, and a “call end” key for ending or “hanging up” a call. Special function keys also may include menu navigation and select keys to facilitate navigating through a menu displayed on the display 24. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality also may be embodied as a touch screen associated with the display 24. Also, the display 24 and keypad 28 may be used in conjunction with one another to implement soft key functionality.

The electronic device 10 includes call circuitry that enables the electronic device 10 to establish a call and/or exchange signals with a called/calling device (e.g., the remote electronic device 18), which typically may be another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The electronic device 10 may be configured to generate, transmit, receive and/or process data, such as text messages, instant messages, electronic mail messages, multimedia messages, image files, video files, audio files, ring tones, streaming audio, streaming video, data feeds (including podcasts and really simple syndication (RSS) data feeds), Internet content, and so forth. It is noted that a text message is commonly referred to by some as “an SMS,” which stands for simple message service. SMS is a typical standard for exchanging text messages. Similarly, a multimedia message is commonly referred to by some as “an MMS,” which stands for multimedia message service. MMS is a typical standard for exchanging multimedia messages. Processing data may include storing the data in the memory 26, executing applications to allow user interaction with the data, displaying video and/or image content associated with the data, outputting audio sounds associated with the data, and so forth.

With continued reference to FIG. 2, the electronic device 10 may include a primary control circuit 30 that is configured to carry out overall control of the functions and operations of the electronic device 10. The control circuit 30 may include a processing device 32, such as a central processing unit (CPU), microcontroller or microprocessor. The processing device 32 executes code stored in a memory (not shown) within the control circuit 30 and/or in a separate memory, such as the memory 26, in order to carry out operation of the electronic device 10. The memory 26 may be, for example, one or more of a buffer, a flash memory, a hard drive, a removable media, a volatile memory, a non-volatile memory, a random access memory (RAM), or other suitable device. In a typical arrangement, the memory 26 may include a non-volatile memory (e.g., a NAND or NOR architecture flash memory) for long term data storage and a volatile memory that functions as system memory for the control circuit 30. The volatile memory may be a RAM implemented with synchronous dynamic random access memory (SDRAM), for example. The memory 26 may exchange data with the control circuit 30 over a data bus. Accompanying control lines and an address bus between the memory 26 and the control circuit 30 also may be present.

The processing device 32 may execute code that implements the call assistant function 20 and the programs 22. It will be apparent to a person having ordinary skill in the art of computer programming, and specifically in application programming for mobile telephones or other electronic devices, how to program a electronic device 10 to operate and carry out logical functions associated with the call assistant function 20. Accordingly, details as to specific programming code have been left out for the sake of brevity. Also, while the call assistant function 20 is executed by the processing device 32 in accordance with an embodiment, such functionality could also be carried out via dedicated hardware or firmware, or some combination of hardware, firmware and/or software.

The electronic device 10 may include an antenna 34 that is coupled to a radio circuit 36. The radio circuit 36 includes a radio frequency transmitter and receiver for transmitting and receiving signals via the antenna 34. The radio circuit 36 may be configured to operate in the communications system 12 and may be used to send and receive data and/or audiovisual content. Receiver types for interaction with the network 14 include, but are not limited to, global system for mobile communications (GSM), code division multiple access (CDMA), wideband CDMA (WCDMA), general packet radio service (GPRS), WiFi, WiMax, etc., as well as advanced versions of these standards. It will be appreciated that the antenna 34 and the radio circuit 36 may represent one or more than one radio transceiver.

The electronic device 10 further includes a sound signal processing circuit 38 for processing audio signals transmitted by and received from the radio circuit 36. Coupled to the sound processing circuit 38 are a speaker 40 and a microphone 42 that enable a user to listen and speak via the electronic device 10. The radio circuit 36 and sound processing circuit 38 are each coupled to the control circuit 30 so as to carry out overall operation. Audio data may be passed from the control circuit 30 to the sound signal processing circuit 38 for playback to the user. The audio data may include, for example, audio data from an audio file stored by the memory 26 and retrieved by the control circuit 30, or received audio data such as in the form of streaming audio data from a mobile radio service. The sound processing circuit 38 may include any appropriate buffers, decoders, amplifiers and so forth.

The display 24 may be coupled to the control circuit 30 by a video processing circuit 44 that converts video data to a video signal used to drive the display 24. The video processing circuit 44 may include any appropriate buffers, decoders, video data processors and so forth. The video data may be generated by the control circuit 30, retrieved from a video file that is stored in the memory 26, derived from an incoming video data stream that is received by the radio circuit 38 or obtained by any other suitable method.

The electronic device 10 may further include one or more input/output (I/O) interface(s) 46. The I/O interface(s) 46 may be in the form of typical mobile telephone I/O interfaces and may include one or more electrical connectors. As is typical, the I/O interface(s) 46 may be used to couple the electronic device 10 to a battery charger to charge a battery of a power supply unit (PSU) 48 within the electronic device 10. In addition, or in the alternative, the I/O interface(s) 46 may serve to connect the electronic device 10 to a headset assembly (e.g., a personal handsfree (PHF) device) that has a wired interface with the electronic device 10. Further, the I/O interface(s) 46 may serve to connect the electronic device 10 to a personal computer or other device via a data cable for the exchange of data. The electronic device 10 may receive operating power via the I/O interface(s) 46 when connected to a vehicle power adapter or an electricity outlet power adapter. The PSU 48 may supply power to operate the electronic device 10 in the absence of an external power source.

The electronic device 10 may include a camera 50 for taking digital pictures and/or movies. Image and/or video files corresponding to the pictures and/or movies may be stored in the memory 26.

The electronic device 10 also may include a position data receiver 52, such as a global positioning system (GPS) receiver, Galileo satellite system receiver or the like. The position data receiver 52 may be involved in determining the location of the electronic device 10.

The electronic device 10 also may include a local wireless interface 54, such as an infrared transceiver and/or an RF interface (e.g., a Bluetooth interface), for establishing communication with an accessory, another mobile radio terminal, a computer or another device. For example, the local wireless interface 54 may operatively couple the electronic device 10 to a headset assembly (e.g., a PHF device) in an embodiment where the headset assembly has a corresponding wireless interface.

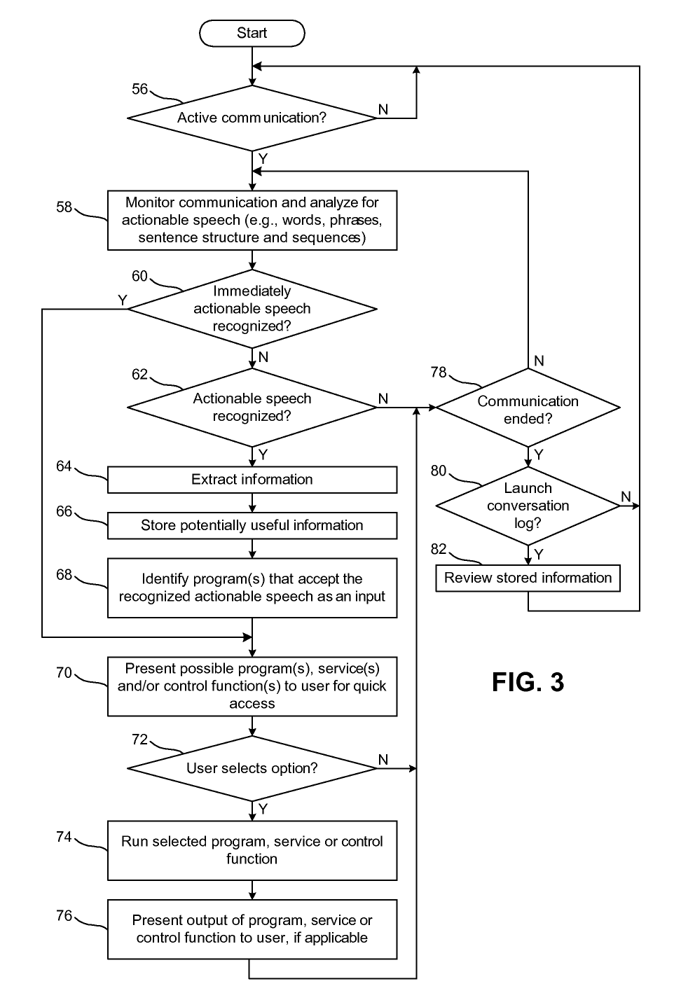

With additional reference to FIG. 3, illustrated are logical operations to implement an exemplary method of actively recognizing and acting upon speech during a voice communication involving the electronic device 10. The exemplary method may be carried out by executing an embodiment of the call assistant function 20, for example. Thus, the flow chart of FIG. 3 may be thought of as depicting steps of a method carried out by the electronic device 10. In other embodiments, some of the steps may be carried out by the server 16.

Although FIG. 3 shows a specific order of executing functional logic blocks, the order of executing the blocks may be changed relative to the order shown. Also, two or more blocks shown in succession may be executed concurrently or with partial concurrence. Certain blocks also may be omitted.

In one embodiment, the functionality described in connection with FIG. 3 may work best if the user uses a headset device (e.g., a PHF) or a speakerphone function to engage in the voice communication. In this manner, the electronic device 10 need not be held against the head of the user so that the user may view the display 24 and/or operate the keypad 28 during the communication.

It will be appreciated that the operations may be applied to incoming audio data (e.g., speech from the user of the remote electronic device 18), outgoing audio data (e.g., speech from the user of the electronic device 10), or both incoming and outgoing audio data.

The logical flow may start in block 56 where a determination may be made as to whether the electronic device 10 is currently being used for an audio (e.g., voice) communication, such as a telephone conversation, a push-to talk-communication, or voice message playback. If the electronic device 10 and is not currently involved in an audio communication, the logical flow may wait until an audio communication commences. If a positive determination is made in block 56, the logical flow they proceeded to block 58.

In the illustrated embodiment, the audio communication is shown as a conversation between a user of the electronic device 10 and the user of the remote device 18 during a telephone call that is established between these two devices. In block 58, this conversation may be monitored for the presence of actionable speech. For instance, speech recognition may be used to convert audio signals containing the voice patterns of the users of the respective devices 10 and 18 into text. This text may be analyzed for predetermined words or phrases that may function as commands or cues to invoke certain action by the electronic device 10, as will be described in greater detail below. Also, an expert system may analyze the text to identify words, phrases, sentence structures, sequences and other spoken information to identify a portion of the conversation upon which action may be taken. In one embodiment, the expert system may be implemented to evaluate the subject matter of the conversation and match this information against programs and functions of the electronic device 10 that may assist the user in during or after the conversation. For this purpose, the expert system may contain a set of matching rules to match certain words and/or phrases that are taken in the context of the surrounding speech of the conversation to match those words and phrases with actionable functions of the electronic device. For example, sentence structures relating to a question about eating, a restaurant, directions, a place, the weather, or other topic may cue the expert system to identify actionable speech. Also, informational statements regarding these or other topics may cue the expert system to identify actionable speech. As an example, an informational statement may start with, “my address is . . . ”

Following block 58, the logic flow may proceed to block 60. In block 60, a determination may be made as to whether immediately actionable speech has been recognized. Immediately actionable speech may be predetermined commands, words or phrases that are used to invoke a corresponding response by the electronic device 10. For example, if the user speaks the phrase “launch web browser,” a positive determination may be made in block 60 and a browser program may be launched. As another example, the user may speak the phrase “volume up” to have the electronic device 10 respond by increasing the speaker volume so that the user may better hear the user of the remote electronic device 18. In this manner, the user may speak predetermined words or phrases to launch one of the programs 22, display certain information (e.g., the time of day, the date, a contact list entry, etc.), start recording the conversation, end recording the conversation, or take any other action that may be associated with a verbal command, all while the electronic device 10 is actually engaged in the call with the remote electronic device 18.

If immediately actionable speech is not recognized in block 60, the logical flow may proceed to block 62. In block 62, a determination may be made as to whether any actionable speech is recognized. The outcome of block 62 may be based on the analysis conducted by the expert system, as described in connection with block 58. As an example, if the user makes statements such as “what,” “what did you say,” “pardon me,” “excuse me,” “could you repeat that,” the expert system may extract the prominent words from these phrases to determine that the user is having difficulty understanding the user of the remote device 18. In this case, the expert system may relate the user's speech to a volume control of the electronic device 10.

As another example, if the users begin to discuss directions regarding how to arrive at a particular destination, the expert system may associate the speech with a mapping service available through an Internet web browser program 22. Similarly, speech relating to eating or restaurants (e.g., one of the users saying “where is a good place to eat” or “where would you like to go to dinner”) may become associated with a restaurant guide and/or a mapping service that is accessible using the Internet web browser 22 or other program 22. Still other speech may be associated with other services, such as movie listings, directories (e.g., residential phone listings, sometimes referred to as “white pages,” and/or business phone listings, sometimes referred to as “yellow pages”), a weather forecast service, etc. As will be appreciated, the expert system may attempt to recognize speech upon which information may be gathered to assist one or both of the users. Identification of this type of speech may be associated with an Internet web browser or other information gathering tool. Depending on the level of ascertainable detail, the speech may be associated with a specific service or a specific Internet webpage, such as one of the above-mentioned search engine, mapping service, weather forecast service, restaurant guide, movie listings, telephone directory, and so forth.

Other speech may lead to the association of the speech with an application for carrying out a task. For example the speech of may invoke a search of a contact list program 22 of the electronic device 10. For instance, if the user were to say “let me find Joe's phone number,” the electronic device may open the user's contact list and search for telephone numbers associated with the name “Joe.” As another example, if the users discuss when to meet in person or to schedule a subsequent telephone call, the speech may be associated with a calendar function and the calendar function may be displayed to the user for easy reference. Other speech may be associated with a messaging program 22, such as an electronic mail function, an instant messaging function, a text message function or a multimedia message function. As an example, if the user were to say “I am e-mailing this picture to you,” an association to an electronic mail function and/or a photograph viewing function may be made. Depending on the amount of information that may be gained from the speech, a specific photograph may be automatically attached to an electronic mail message and/or the electronic mail message may be automatically addressed using a stored e-mail address from the user's contact list.

In other situations, one of the users may orally provide the other user with valuable information, such as a telephone number, a street address, directions, an electronic mail address, a date and time of the meeting, or other information. The expert system may be configured to recognize the conveyance of information by the format of the information. For example, sequences of numbers that may represent a telephone number. Other speech may indicate a street address (e.g., numbers that are used in conjunction with one of the words street, road, boulevard, avenue, etc.). Other information may be an electronic mail address, an instant message address, directions (e.g., instructions that contain one or more of the words turn, go straight, right, left, highway, etc.), or other information. When this type of speech is recognized, the electronic device 10 may store the information. Storing information may occur by storing a text log of the converted speech, storing an audio file containing the audio communication itself for future playback by the user, or both of these storage techniques.

Following a positive determination in block 62, the logical flow may proceed to block 64. In block 64, items of information may be extracted from the speech. Exemplary items of information are described above and may include, but are not limited to a street address, a person's name, a place, a movie name, a date and/or time, a telephone number, an electronic mail address, or any other identifiable information from the conversation. As will be described, this information may be input to one of the programs 22 for further processing. Additional information may be gathered from other sources. For instance, position information that identifies a location of the electronic device 10 and/or the remote election device 18 may be obtained. For instance, the position information may be formatted as GPS location data. The location information may be used, for example, to provide directions to the user of the electronic device 10 and/or the user of the remote device 18 to a particular destination.

The logical flow may proceed to block 66 where information that is identified as having potential use to the user may be stored in a conversation log. As indicated, information may be stored in text format, an audio format, or both the text and audio formats.

In block 68, programs 22 that may be of use to the user based on the detected actionable speech may be identified. The identified programs 22 may be the programs that are associated with the speech as described above, such as programs that may accept the recognized actionable speech as an input. As indicated, the programs may include an Internet Web browser or other information gathering tool, an electronic mail message program or other messaging program, a contact list database, a calendar function, a clock function, a setting control function of the electronic device 10, or any other applicable application. In addition, the identification of the program 22 that may act on the actionable speech may include the identification of a particular function, feature, service, or Internet webpage that is accessible using the identified program.

Following block 68, or following a positive determination in block 60, the logical flow may proceed to block 70. In block 70, the user may be presented with a list of programs 22 that may be of use to the user as based on the actionable speech that was detected. The list may specifically identify executable programs, services and/or control functions that have a logical relationship to the actionable speech. The items displayed to the user may be selectable so that the user may select a displayed option to quickly access the associated program, service or control function. In some situations, actionable speech may correspond to a feature that may be carried out without user interaction. In that case, presenting options to the user based on the actionable speech may be omitted and the appropriate program 22 may be automatically invoked to carry out an action corresponding to the actionable speech and any associated extracted information.

Following block 70, the logical flow may proceed to block 72 where a determination is made as to as to whether the user selects a displayed option. If the user selects a displayed option, the logical flow may proceed to block 74 where the program 22 associated with the selected option is run to carry out a corresponding task. These corresponding tasks may include, but are not limited to, carrying out a control action (e.g., adjusting a volume setting), searching and retrieving information from a contact list entry, storing information in a contact list entry, commencing the generation of a message, interacting with a calendar function, launching an Internet Web browser and browsing to a particular service (e.g., a restaurant guide, a mapping service, a movie listing, a weather forecast service, a telephone directory, and so forth), conducting an Internet search. Following block 74, the logical flow may proceed to block 76 where, if appropriate, output from the program 22 that is run in block 74 may be displayed to the user. For instance, directions an interactive map from a mapping service may be displayed on the display 24.

Following a negative determination in either of blocks 62 or 72, or following block 76, the logical flow may proceed to block 78. In block 78, a determination may be made as to whether the audio communication has ended. If not, the logical flow may return to block 58 to continue to monitor the audio communication for additional actionable speech. If it has been determined in block 78 that the conversation has ended, the logical flow may proceed to block 80.

In block 80, a determination may be made as to whether the user has selected an option to open a conversation log for the audio communication. As indicated, the conversation log may be in a text format and/or an audio format. In one embodiment, so long as actionable speech was detected to prompt the storage of a conversation log, the user may be provided with an opportunity to open and review the log following completion of the audio communication or during the audio communication. Also, historical conversation logs may be stored for user reference at some time in the future.

If the user does not launch the conversation log, the logical flow may return to block 56 to await the initiation of another audio communication. If the user does launch the communication log in block 80, the logical flow may proceed to block 82 where the user may review the stored information. For example, the user may read through stored text to retrieve information, such as directions, an address, a telephone number, a person's name, an electronic mail address, and so forth. If the user reviews an audio file containing a recording of the audio communication, the user can listen for information of interest. In one embodiment, the communication log may store information regarding the entire audio communication. In other embodiments, the conversation log may contain text and/or audio information relating to portions of the audio communication that were found to have an actionable speech component. Following block 82 to the logical flow may return to block 56 to wait for another audio communication to start.

In the foregoing description, examples of the described functionality are given with respect to the English language. It will be appreciated that the language analysis, primarily through the rules of the expert system, may be adapted for languages other than English. For instance, a conversation may be monitored for directions from one location to another regardless of the underlying language by detecting phrases and words that are commonly used with directions and by analyzing the sentence structure that contains those words and phrases. Then, driving or other travel directions may be extracted from the voice communication and the extracted information may be stored for future use. Similarly, an address may be extracted from the conversation and used as an input to a mapping service to obtain directions to that location and a map of the surrounding area.

The described techniques may offer the user an easy to use interface with the electronic device 10 that may be used during a telephone call or other voice communication. The techniques allow the user to interact with the electronic device using pertinent information from the voice communication.

Although certain embodiments have been shown and described, it is understood that equivalents and modifications falling within the scope of the appended claims will occur to others who are skilled in the art upon the reading and understanding of this specification.

What is claimed is:

1. An electronic device that actively recognizes speech during a voice communication, comprising a control circuit that converts the voice communication to text and analyzes the text to detect speech that is actionable by a program, the actionable speech corresponding to a command or data input upon which the program acts.

2. The electronic device of claim 1, wherein the control circuit further runs the program based on the actionable speech.

3. The electronic device of claim 1, wherein the analysis is carried out by an expert system that analyzes words and phrases in the context of surrounding sentence structure to detect the actionable speech.

4. The electronic device of claim 1, wherein the electronic device is a server, and the server transmits the command or data input to a client device that runs the program in response to the command or data input.

5. The electronic device of claim 1, wherein the program is an Internet browser.

6. The electronic device of claim 5, wherein the actionable speech is used to direct the Internet browser to a specific Internet webpage for accessing a corresponding service.

7. The electronic device of claim 6, wherein the service is selected from one of a mapping and directions service, a directory service, a weather forecast service, a restaurant guide, or a movie listing service.

8. The electronic device of claim 1, wherein the program is a messaging program to generate one of an electronic mail message, an instant message, a text message or a multimedia message.

9. The electronic device of claim 1, wherein the program is a contact list.

10. The electronic device of claim 1, wherein the program is a calendar program for storing appointment entries.

11. The electronic device of claim 1, wherein the program controls a setting of the electronic device.

12. The electronic device of claim 1, wherein the electronic device is a mobile telephone and the voice communication is a telephone call.

13. An electronic device that actively recognizes speech during a voice communication, comprising:
a control circuit that converts the voice communication to text and analyzes the text to detect actionable speech, the actionable speech corresponding to information that has value to a user following an end of the voice communication; and
a memory that stores the actionable speech in a conversation log.

14. The electronic device of claim 13, wherein the conversation log is in a text format that contains text corresponding to the actionable speech.

15. The electronic device of claim 13, wherein the conversation log is in an audio format that contains audio data from the voice communication that corresponds to the actionable speech.

16. The electronic device of claim 13, wherein the actionable speech corresponds to at least one of a name, a telephone number, an electronic mail address, a messaging address, a street address, a place, directions to a destination, a date, a time, or combinations thereof.

17. A method of actively recognizing and acting upon speech during a voice communication using an electronic device, comprising:
converting the voice communication to text;
analyzing the text to detect speech that is actionable by a program of the electronic device, the actionable speech corresponding to a command or data input upon which the program acts; and
running the program based on the actionable speech.

18. The method of claim 17, wherein the analysis is carried out by an expert system that analyzes words and phrases in the context of surrounding sentence structure to detect the actionable speech.

19. The method of claim 17, wherein the program is run following user selection of an option to run the program.

20. The method of claim 17, wherein the program is an Internet browser.

21. The method of claim 17, wherein the actionable speech is used to direct the Internet browser to a specific Internet webpage for accessing a corresponding service.

22. The method of claim 21, wherein the service is selected from one of a mapping and directions service, a directory service, a weather forecast service, a restaurant guide, or a movie listing service.

23. The method of claim 22, wherein the program is a messaging program to generate one of an electronic mail message, an instant message, a text message or a multimedia message.

24. The method of claim 17, wherein the program is a contact list.

25. The method of claim 17, wherein the program is a calendar program for storing appointment entries.

26. The method of claim 17, wherein the program controls a setting of the electronic device.

27. A method of actively recognizing and acting upon speech during a voice communication using an electronic device, comprising:
converting the voice communication to text;
analyzing the text to detect actionable speech, the actionable speech corresponding to information that has value to a user following an end of the voice communication; and
storing the actionable speech in a conversation log.

28. The method of claim 27, wherein the conversation log is in a text format that contains text corresponding to the actionable speech.

29. The method of claim 27, wherein the conversation log is in an audio format that contains audio data from the voice communication that corresponds to the actionable speech.

30. The method of claim 27, wherein the actionable speech corresponds to at least one of a name, a telephone number, an electronic mail address, a messaging address, a street address, a place, directions to a destination, a date, a time, or combinations thereof.
